(19) United States
(12) Patent Application Publication
(10) Pub. No.: US 2014/0187398 A1
(43) Pub. Date: Jul. 3, 2014

(54) MACHINE TOOL AND METHOD FOR CHANGING TOOLS ON A MACHINE TOOL

(71) Applicant: MAG IAS GmbH, Goeppingen (DE)

(72) Inventors: Tobias Abeln, Stuttgart (DE); Walter Pompe, Gingen/Fils (DE); Benedikt Ell, Geislingen (DE); Markus Gunzenhauser, Boehmenkirch (DE); Gerhard Hommel, Geislingen (DE)

(73) Assignee: MAG IAS GmbH, Goeppingen (DE)

(21) Appl. No.: 14/200,583

(22) Filed: Mar. 7, 2014

Related U.S. Application Data
(63) Continuation of application No. PCT/EP2012/067368, filed on Sep. 6, 2012.

(30) Foreign Application Priority Data
Sep. 9, 2011 (DE) 102011053455.5

(51) Int. Cl. B23Q 3/155; B23Q 3/157

(52) U.S. Cl. CPC B23Q 3/15526; B23Q 3/157; B23Q 3/15513; B23Q 3/1554
USPC 483/1; 483/36; 483/37; 483/51

(57) ABSTRACT

There is provided a machine tool including a machine frame, at least one tool spindle which is arranged on the machine frame and is displaceable relative thereto, a workpiece holder and a storage device for tools which is arranged on the machine frame, wherein at least one rotatable disk-type storage unit for tools is arranged on the machine frame and communicates with the storage device and with the at least one tool spindle, wherein a separate disk-type storage unit is associated with each tool spindle and wherein the storage device includes a circulating conveyor.

### CROSS-REFERENCE TO RELATED APPLICATIONS

The present application is a continuation of international application number PCT/EP2012/067368, filed on Sep. 6, 2012, which claims the benefit of German application number 10 2011 053 455.5, filed on Sep. 9, 2011, the entire specification of both being incorporated herein by reference.

### BACKGROUND OF THE INVENTION

The invention relates to a machine tool which comprises a machine frame, at least one tool spindle which is arranged on the machine frame and is displaceable relative thereto, a workpiece holder and a storage device for tools which is arranged on the machine frame.

The invention also relates to a method for changing tools on a machine tool.

From DE 90 14 433 U1 there is known a machine tool for machining processing by means of rotating tools. A tool changer with a double grip is provided.

From DE 201 18 456 U1 there is known a machine tool in which a separate tool changing device with a disk-type magazine is associated with each work spindle, wherein the disk-type magazines are each arranged on a corresponding machine column.

From DE 10 2009 041 075 A1 there is known a machining center in a gantry configuration with a tool magazine which is arranged between the side walls of a U-shaped machine frame and has displaceable tool holders and a tool rack magazine of modular construction and a three-dimensional gantry design arranged laterally externally on the U-shaped machine frame and having statically mounted tool holders and a tool transfer point provided between the tool magazine and the tool rack magazine.

From DE 87 16 086 there is known an auxiliary magazine for program-controlled machine tools.

### SUMMARY OF THE INVENTION

In accordance with the present invention, a machine tool is provided wherein a time-efficient tool change can be achieved at the at least one tool spindle with short chip-to-chip times.

In accordance with an embodiment of the invention, in the machine tool at least one rotatable disk-type storage unit for tools is arranged on the machine frame and communicates with the storage device and with the at least one tool spindle, wherein a separate disk-type storage unit is associated with each tool spindle, and wherein the storage device comprises a circulating conveyor.

The machine tool according to the invention has basically two types of tool stores, specifically, as a first magazine, the storage device at the machine frame. This constitutes a background magazine for tools. Furthermore, at least one disk-type storage unit is provided which constitutes a second magazine for tools.

A plurality of tools can be stored in the disk-type storage unit. A tool change at a tool spindle is performed directly by accessing the disk-type storage unit.

In this way, short tool change times and thus short chip-to-chip times of, for example, less than 3 seconds are achievable. Since a plurality of tools can be provided in the disk-type storage unit, minimized tool change times can be achieved even for complex machining operations on workpieces for which a plurality of different tools are needed.

A separate disk-type storage unit is associated with each tool spindle. If, for example, two tool spindles are provided, then two disk-type storage units are provided. This results in time-efficient workpiece machining, in particular since a synchronous tool change at the tool spindles is made possible.

A disk-type storage unit can be easily brought into a tool change position in that the storage space having the tool to be substituted-in is rotated into a change position.

The storage device comprises a circulating conveyor which is configured, in particular, as a chain conveyor. In this way, a storage capacity can be achieved over essentially the whole surface of the storage device. An endless construction using a circulating conveyor enables tools to be transported in a simple way and, for example, to be fed to the at least one disk-type storage unit.

In particular, at least one first tool spindle is provided which is associated with a first disk-type storage unit and a second tool spindle is provided which is associated with a second disk-type storage unit. By this means, synchronous tool change can be carried out during simultaneous machining operation, including for a plurality of tool spindles.

In particular, the storage device constitutes a first magazine for tools and the at least one disk-type storage unit constitutes a second magazine for tools. The first magazine is a background magazine which keeps a large quantity of tools ready. The second magazine is a tool magazine which enables effective tool change with a tool spindle (with short chip-to-chip times) wherein the second magazine can also keep ready a plurality of tools in order to be able to carry out complex machining operations with tool changing during simultaneous machining operation.

In particular, a storage capacity of the first magazine for tools is greater than the storage capacity of the at least one disk-type storage unit. In this way, firstly a large number of tools can be stored at the machine tool and, secondly, a time-efficient tool change can be carried out by means of the second magazine.

In one embodiment, the storage device comprises at least 30 storage spaces for tools. In particular, the storage device comprises at least 50, and preferably at least 80 storage spaces.

In a further embodiment, the at least one disk-type storage unit comprises, for example, in the range of 5 to 15 storage spaces for tools. In this way, the diameter of the disk-type storage unit can be kept small.

In particular, the storage device has a region with storage spaces which lies above a working space and has a region which lies beside the working space. Using the region above the working space, tools can be made available to the at least one disk-type storage unit. Using the region beside the working space, tools can be fed to and removed from the storage device. For example, tools can be fed in and removed manually.

If manual feeding is provided for, then it is particularly advantageous if the region lying beside the working space is at a spacing of not more than 1.5 m from a foundation on which the machine bed stands. A tool therefore does not have to be lifted “above the head” of an operator. In principle, the smaller the spacing from the floor, the greater is the storage capacity. A small spacing can also be advantageous in the case of automatic supplying and removal of tools.

For example, the storage device has an L-shaped form in plan view. The region above the working space and the region beside the working space are oriented transversely to one another.

It is advantageous if at least one transfer station is provided between the storage device and the at least one disk-type storage unit. The transport of tools between the storage device and the at least one disk-type storage unit can be carried out by means of the at least one transfer station.

In an exemplary embodiment, the at least one transfer station is movable between the storage device and the at least one disk-type storage unit. Transport between the storage device and the at least one disk-type storage unit can be carried out by a movement of the at least one transfer station.

It is favorable if the at least one transfer station has two receiving spaces. In this way, the transfer station can, for example, simultaneously fetch a tool at one magazine and deposit a tool at the other magazine.

In this regard, it is favorable if an individual transfer station is associated with each disk-type storage unit.

In another exemplary embodiment, the transfer station comprises a carriage which is displaceable on the machine frame and on which the at least one disk-type storage unit is arranged. It is then possible, in principle, for a direct exchange of tools to take place between the storage device and the disk-type storage unit, so that the disk-type storage unit passes a tool directly to the storage device or fetches the tool directly therefrom.

In another exemplary embodiment, the at least one disk-type storage unit is arranged on a carriage which is displaceable on the machine frame, in particular, in a direction (Z-direction) parallel to a longitudinal direction of the at least one tool spindle. A displacement movement of the at least one disk-type storage unit relative to the machine frame can thus be achieved. This can be advantageous for the provision of a transfer station. Alternatively or additionally, by means of a displaceable carriage of this type, the at least one disk-type storage unit can be guided to the at least one tool spindle in order to simplify or enable a tool change. The movability of the carriage in the longitudinal direction of the at least one tool spindle (in a Z-direction) also enables a lifting-out movement.

In particular, the carriage is displaceable in a first direction transversely to a longitudinal direction of the at least one tool spindle and, in particular, in a second direction transversely to the first direction and the longitudinal direction.

It is favorable if an intermediate storage device for tools is provided which communicates with the storage device and with the at least one tool spindle, wherein at least one lifting-out device is arranged on the intermediate storage device, by means of which lifting-out device a tool is displaceable in a direction parallel to a tool spindle longitudinal direction.

With a lifting-out device of this type, a Z-displacement is possible, particularly in order to release the fixing of a tool at a tool spindle and to fix a tool at a tool spindle by a lifting movement in the opposing direction.

In accordance with the invention, a method is provided with which a time-efficient tool change can be achieved.

In accordance with an embodiment of the invention, a first storage device and a second storage device are provided, wherein the second storage device communicates with the first storage device and with a tool spindle and an exchange of a tool at the tool spindle is carried out with the second storage device, wherein a separate second storage device is associated with each tool spindle and wherein the first storage device comprises a circulating conveyor by means of which storage spaces are transported in a closed circuit.

The method according to the invention has the advantages set out above in relation to the machine tool according to the invention.

Further advantageous embodiments have also already been set out above in relation to the machine tool according to the invention.

In particular, the second storage device is provided by at least one rotatable disk-type storage unit.

The invention will now be described in greater detail making reference to preferred embodiments and the drawings.

### BRIEF DESCRIPTION OF THE DRAWINGS

FIG. 1 shows a perspective view of an exemplary embodiment of a machine tool according to the invention (without the cover and with a partial representation of a storage device), wherein tools are indicated by an interfering contour;

FIG. 2 shows the machine tool of FIG. 1 in a side view;

FIG. 3 shows the machine tool of FIG. 1 in a front view;

FIG. 4 shows an exemplary embodiment of a storage device (first magazine) with disk-type storage units (second magazine) in the machine tool of FIG. 1;

FIG. 5 shows a view of the storage system of FIG. 4 from another side;

FIG. 6 shows a second exemplary embodiment of a storage system wherein tools are indicated by an interfering contour;

FIG. 7 shows a view of a chain-type storage device according to FIG. 6 in the direction A and in a lifting-out position;

FIG. 8 shows the same view as FIG. 7 in a not lifted-out position;

FIG. 9 shows a sectional view along the line 9,10-9,10 according to FIG. 6 in the lifted-out position;

FIG. 10 shows the same view as FIG. 9 in the not lifted-out position;

FIG. 11 shows a sectional view along the line 11,12-11,12 according to FIG. 6 in the lifted-out position; and

FIG. 12 shows the same view as FIG. 11 in the not lifted-out position.

### DETAILED DESCRIPTION OF THE INVENTION

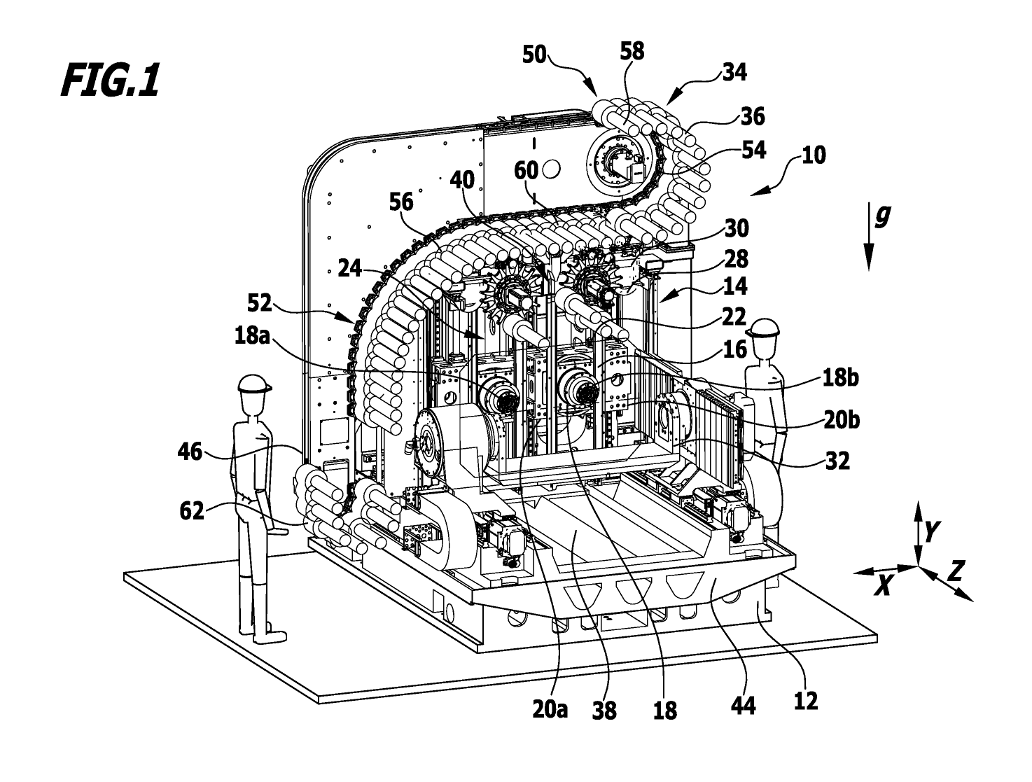

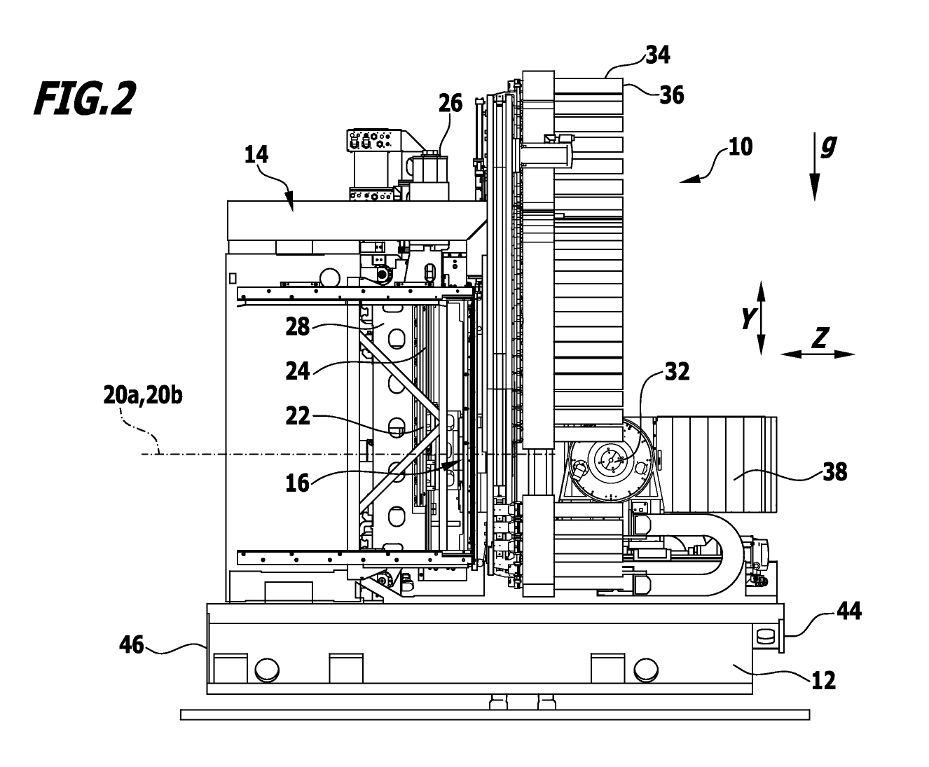

One exemplary embodiment of a machine tool is a machining center. One embodiment of a machining center, which is shown schematically in FIGS. 1 to 3 in a partial representation (without the cover) and is identified as 10 there, comprises a machine bed 12 on which a machine frame 14 is arranged. The machine frame 14 has a portal type of configuration and extends beyond the machine bed 12 in a vertical direction relative to the direction of gravity g. Mounted on the machine frame 14 is a tool carrier device 16 which comprises at least one tool spindle 18.

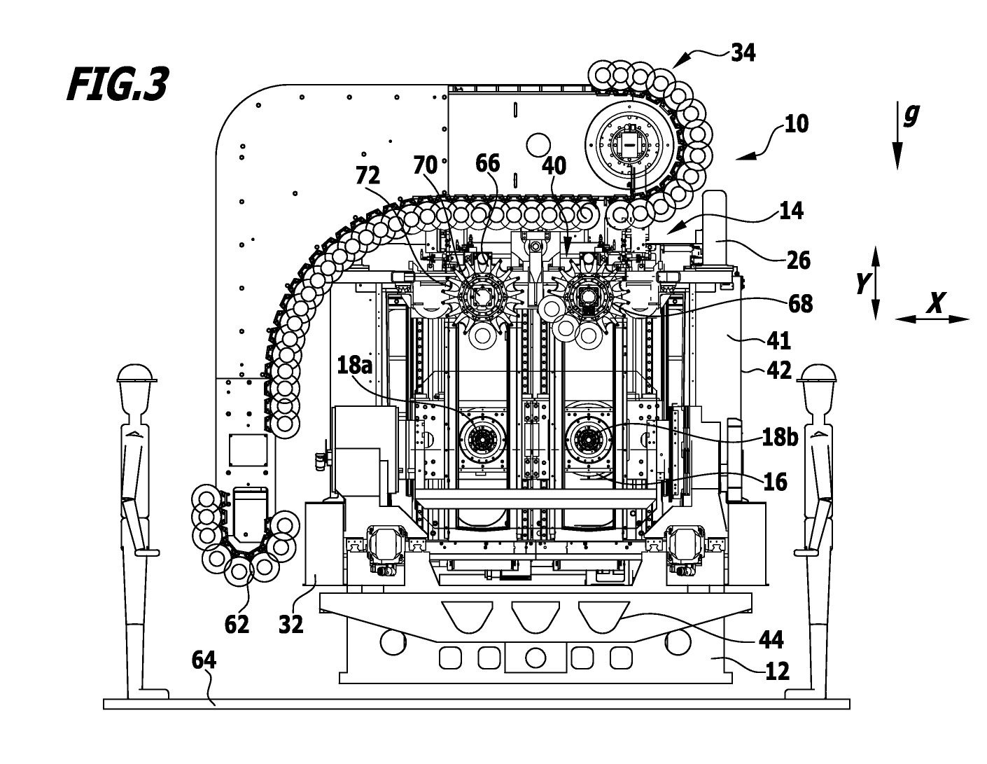

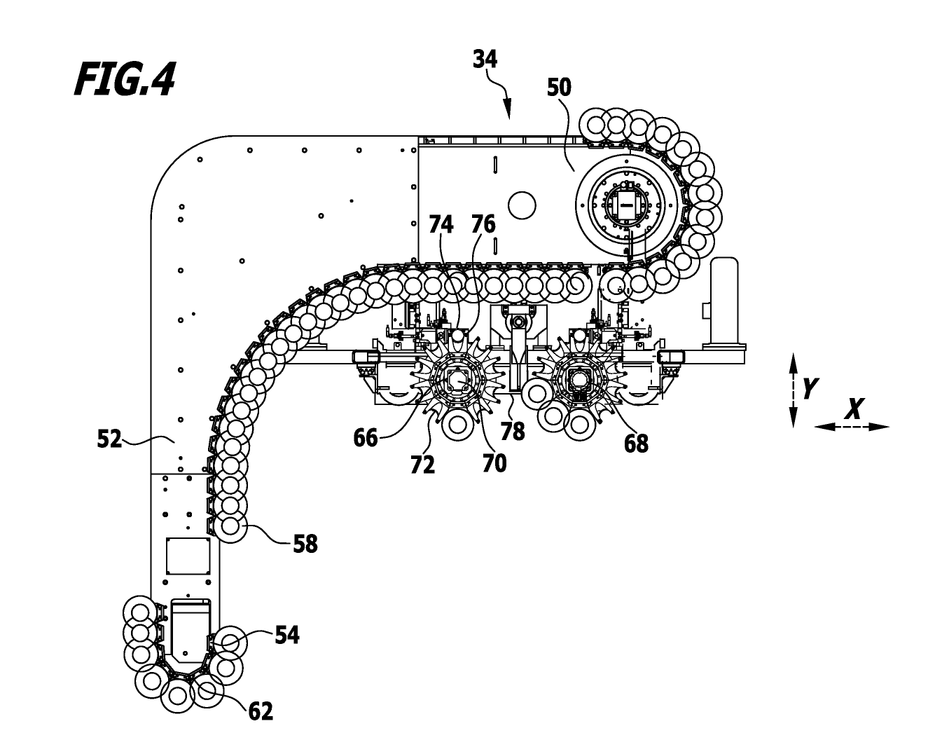

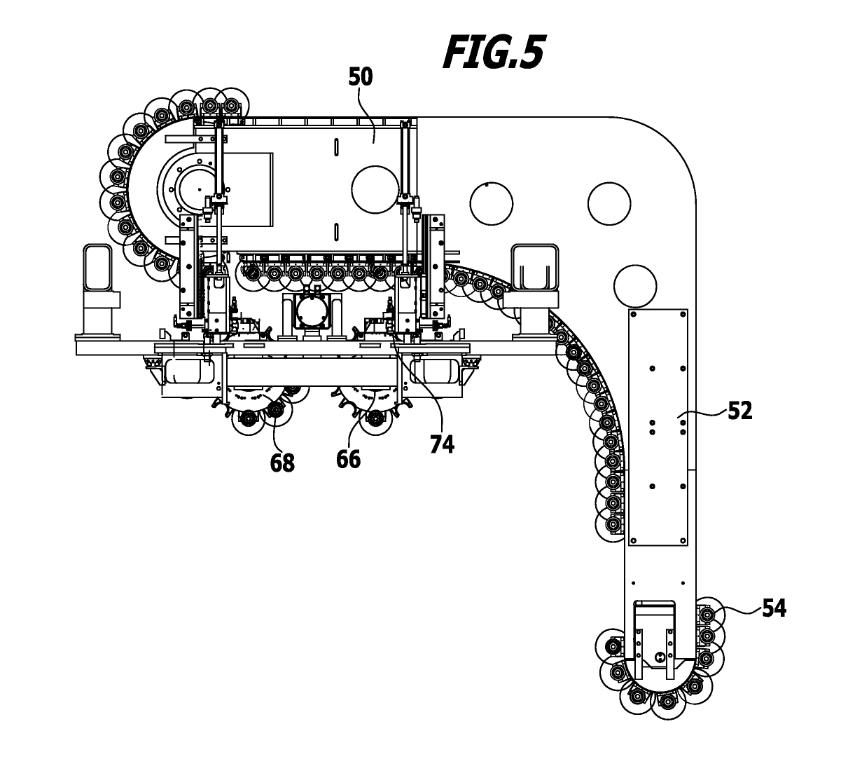

In the exemplary embodiment shown, the tool carrier device 16 comprises a first tool spindle 18a and a second tool spindle 18b. A tool held at the respective tool spindles 18a, 18b is rotatable about a rotation axis 20a, 20b. The rotation axes 20a, 20b lie parallel to one another. They are oriented parallel to a Z-direction which, in the representation according to FIG. 3, lies perpendicularly to the drawing plane. The Z-direction is, in particular, a horizontal direction relative to the gravity direction g.

The tool carrier device 16 is configured as a carriage 22 which is held on a carriage guideway 24 and is linearly movable via the carriage guideway 24 in a Y-direction (forward and backward), The Y-direction lies transversely and, in particular, perpendicularly to the Z-direction. The Y-direction is, in particular, a vertical direction relative to the gravity direction g.

In order to drive the movement of the carriage 22 in the Y-direction and for positioning thereof, a drive device 26 is associated with the carriage 22. Said drive device can comprise a ball screw drive or a linear motor.

The carriage 22 is itself held on a carriage 28 which is linearly displaceable in an X-direction (forward and backward) on a carriage guideway 30. For displacement and positioning, a corresponding drive is provided. The X-direction is transverse and, in particular, perpendicular to the Y-direction and the Z-direction. The X-direction is, in particular, a horizontal direction relative to the gravity direction g.

At least one workpiece holder 32 is arranged on the machine bed 12. The first tool spindle 18a and the second tool spindle 18b and therefore tools held thereon and the workpiece holder 32 are movable relative to one another in the Z-direction (forward and backward). A workpiece held on the workpiece holder 32 and the tool spindle 18a or 18b are therefore displaceable relative to one another in the X-direction as the first direction, the Y-direction as the second direction and the Z-direction as the third direction.

In one exemplary embodiment, the tool spindles 18a, 18b are not moveable in the Z-direction for machining a workpiece and the workpiece holder 32 is held on the machine bed displaceably in the Z-direction. For this purpose, a drive is associated with the workpiece holder 32.

In an alternative exemplary embodiment, the first tool spindle 18a and the second tool spindle 18b are displaceably held on the tool carrier device 16 in order to enable a Z-displaceability.

It is also possible to combine a Z-displaceability of the tool spindles 18a, 18b at the tool carrier device 16 and a Z-displaceability of the workpiece holder 32 on the machine bed.

It can also be provided, for example, that the workpiece holder 32 is rotatable, for example, about a vertical axis and/or a horizontal axis.

A machining center of this type is disclosed, for example, in W02009/033920 A1. Reference is made to this document, which is also incorporated within the present disclosure.

In the exemplary embodiment illustrated, the machining center 10 has a storage device 34 for tools 36 which is arranged with a part thereof above a working space 38 in which workpieces are machined. The tools 36 are indicated with the interfering contours (maximum external dimensions) thereof.

Furthermore, a tool changing device 40 is provided by means of which tools 36 can be inserted on, and removed from, the tool spindles 18a and 18b.

The machining center 10 may also comprise only a single tool spindle or more than two tool spindles.

The machining center 10 has a control device 41 which is arranged at least partially in a switchgear cabinet 42. Sequences of the workpiece machining can be controlled with the control device 41.

The machining center 10 has a front side 44 and a rear side 46. The working space 38 faces the front side 44.

The storage device 34 is part of a storage system 48. The storage device 34, which is arranged on the machine frame 14, comprises a first region 50 which is arranged above the working space 38. Furthermore, the storage device 34 comprises a second region 52 which is arranged laterally beside the working space. The storage device 34 has an L-shaped form in plan view. The storage device comprises a circulating conveyor 54 which is configured, in particular, as a chain conveyor. Storage spaces 56 are arranged on the circulating conveyor 54, each storage space 56 being able to receive a tool 58. A storage space 56 has a suitable interface, for example, for an HSK mounting. With the circulating conveyor 54, the storage spaces 56 and thus also the tools 58 can be transported in a closed circuit. In this way, tools 58 can be provided to the tool spindles 18a, 18b in a region 60 above (relative to the direction of gravity g) the working space 38.

At a bottom side 62, the second region 52 of the storage device 34 is at a spacing (see, in particular, FIG. 3) of no more than 1.5 m from a floor 64. Therefore, an operator can load and unload the storage device 34 in the vicinity of the bottom side 62, which means, in particular, that tools can be exchanged manually there. It is also possible, for example, for a dedicated tool loading/unloading station to be associated with the second region 52, by means of which the storage device 34 is automatically loadable and unloadable.

The storage device 34 constitutes a first magazine for tools for the machine tool 10. It has a plurality of storage spaces 56. In particular, the storage device has more than thirty storage spaces. In one exemplary embodiment, the first storage device 34 has ninety-two storage spaces 56.

The storage system 48 also comprises a first disk-type storage unit 66 and a second disk-type storage unit 68. The first disk-type storage unit 66 is associated with the first tool spindle 18a and the second disk-type storage unit 68 is associated with the second tool spindle 18b.

The disk-type storage units 66, 68 are each rotatable about an axis 70 on the machine frame 14. The rotary axis 70 is oriented parallel to the Z-direction.

The first disk-type storage unit 66 and the second disk-type storage unit 68 are spaced apart from one another in the X-direction. This spacing between the first disk-type storage unit 66 and the second disk-type storage unit 68 is, in particular, fixed.

The first disk-type storage unit 66 and the second disk-type storage unit 68 are arranged between the working space 38 and the first region 50 of the storage device 34. They are, in particular, positioned beneath the first region 50 of the storage device 34 and above the working space 38. The first disk-type storage unit 66 and the second disk-type storage unit 68 communicate with the storage device 34 (specifically with the first region 50 therein) and the associated tool spindles 18a and/or 18b.

A disk-type storage unit 66 or 68 has a plurality of storage spaces 72 which are arranged on a circular disk. A storage space 72 comprises, for example, an HSK interface. The storage spaces 72 are distributed round the periphery of the respective disk-type storage unit 66 or 68, specifically such that a tool stored at a storage space 72 can be removed from outside.

The disk-type storage units 66 and 68 constitute a second magazine (buffer magazine) for tools, wherein the number of storage spaces 72 in the first disk-type storage unit 66 and the second disk-type storage unit 68, respectively, is smaller than the number of storage spaces 56 in the storage device 34. For example, the first disk-type storage unit 66 and the second disk-type storage unit 68 each have a total of ten storage spaces 72.

In particular, the first disk-type storage unit 66 and the second disk-type storage unit 68 are configured to be identical.

At least one transfer station 74 is provided which serves to transfer tools between the storage device 34 and the respective disk-type storage unit 66, 68. The transfer station 74 has at least one space 76 for a tool. By means of this space 76, a tool can be received at the relevant disk-type storage unit 66, 68 and transported to the storage device 34 (at the first region 50 there) or, conversely, a tool can be removed from the disk-type storage unit 34 and then transported to the corresponding disk-type storage unit 66 or 68.

In one exemplary embodiment, the transfer station 74 comprises two spaces 76 so that two tools can be received simultaneously.

The transfer station 74 is configured to be movable in order to enable transfer between the storage device 34 and the respective disk-type storage unit 66, 68.

The transfer station 74 comprises, for example, a carriage for a linear movement between the first region 50 of the storage device 34 and the corresponding disk-type storage unit 66, 68 or, for example, a pivotable element.

In particular, a respective transfer station 74 is associated with each of the first disk-type storage unit 66 and the second disk-type storage unit 68.

It is also possible, in principle, for the first disk-type storage unit 66 and the second disk-type storage unit 68 to be arranged on a carriage which is movable on the machine frame 14. Said carriage is movable, for example, in the Y-direction or in the X-direction or in the Y-direction and the X-direction.

A transfer device can be formed by a carriage of this type. Through the movement of the carriage, the disk-type storage units 66, 68 can be driven into the vicinity of the first region 50 of the storage device in order to enable a direct transfer.

It is also possible, even if transfer stations 74 are provided, for the first disk-type storage unit 66 and the second disk-type storage unit 68 to be arranged on a carriage 78 which is movable in the X-direction and/or the Y-direction and/or the Z-direction. The carriage can therefore be guided with the first disk-type storage unit 66 and the second disk-type storage unit 68 to the tool spindles 18a, 18b.

It is alternatively possible, for a tool change, that the tool spindles 18a, 18b are guided to the disk-type storage units 66, 68 in such a way that a tool change is enabled.

It can also be provided, for example, that the carriage 78 has movability only in the Z-direction. The Z-direction is parallel to a longitudinal extent of the tool spindles 18a, 18b. A suitable displaceability of the carriage 78 in the Z-direction enables a lifting-out movement for a tool to be made.

The machine tool according to the invention has the following functions in relation to tool changes.

The first storage device 34 constitutes a background (first) magazine for tools. With the disk-type storage units 66, 68, wherein precisely one disk-type storage unit is associated with each tool spindle (the first disk-type storage unit 66 is associated with the first tool spindle 18a and the second disk-type storage unit 68 is associated with the second tool spindle 18b), a buffer store for tools is provided wherein the transfer station or transfer stations 74 provide for the transfer of tools between the storage device 34 and the disk-type storage units 66, 68. The tool spindles 18a, 18b fetch tools from the disk-type storage units 66, 68 or deliver tools thereto. (The delivery process or the fetching process can be carried out actively by means of the tool spindles 18a, 18b in that said tool spindles move toward the disk-type storage units 66, 68, or a passive process is possible in principle, in that if the disk-type storage units 66, 68 are arranged on the carriage 78, the carriage 78 moves toward the tool spindles 18a, 18b. A combined active approach of both the tool spindles 18a, 18b and the carriage 78 is also possible.)

The disk-type storage units 66, 68 each accept a smaller number of tools than the storage device 34.

In principle, the storage system 48 with the background magazine (the storage device 34) and the buffer stores (the first disk-type storage unit 66 and the second disk-type storage unit 68) has a large capacity for accommodating tools. Since a relatively large number of tools can be held in reserve in the disk-type storage units 66, 68 and said storage units are arranged directly at the edge of the working space 38, even during relatively complex machining operations for which a plurality of tools is required, a short provision time can be realized for tools for the tool spindles 18a, 18b. The result is a short chip-to-chip time of, for example, less than 3 s.

The background magazine 34 permits a tool change to be performed easily and rapidly at the disk-type storage units 66, 68.

Since each tool spindle 18a, 18b is associated with one, and particularly precisely one, disk-type storage unit 66 or 68, a rapid tool change can be provided even if a tool change is to be carried out, particularly synchronously, at a plurality of tool spindles. In particular, in this way, synchronous machining operations can be carried out on two workpieces within the same machine tool and with short chip-to-chip times.

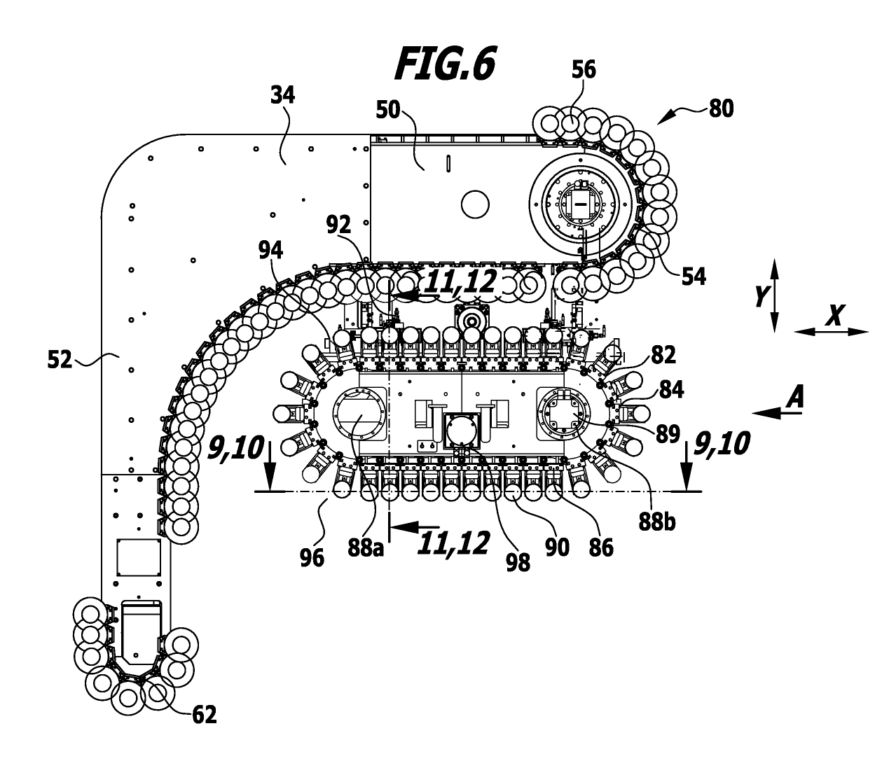

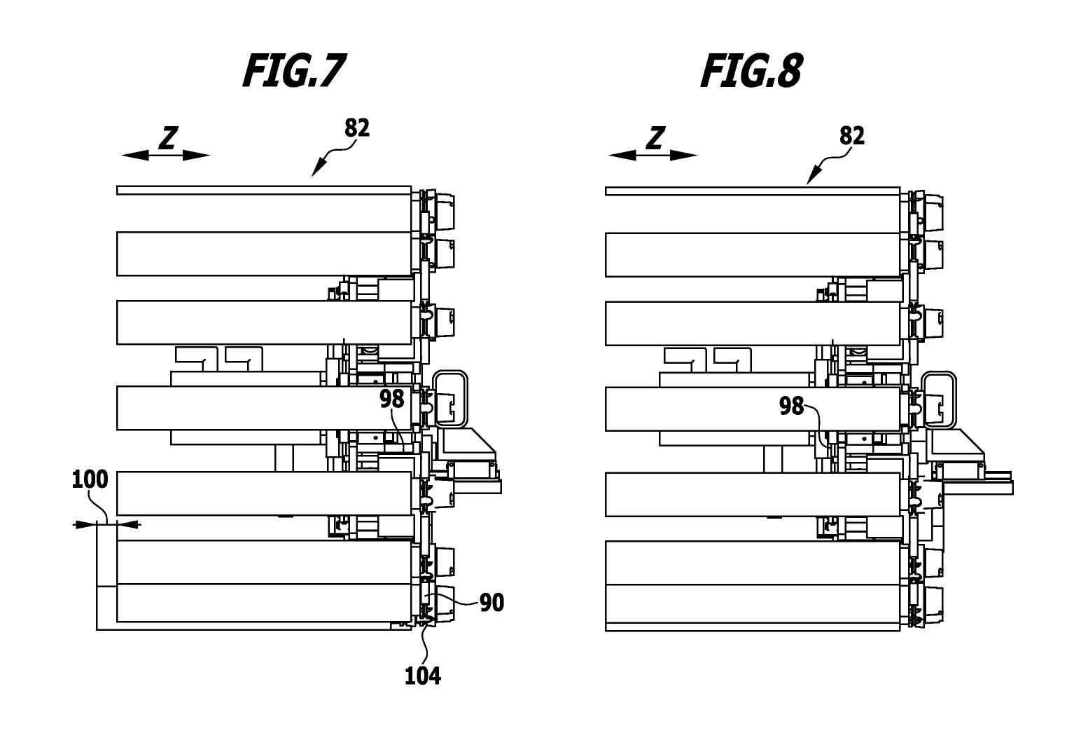

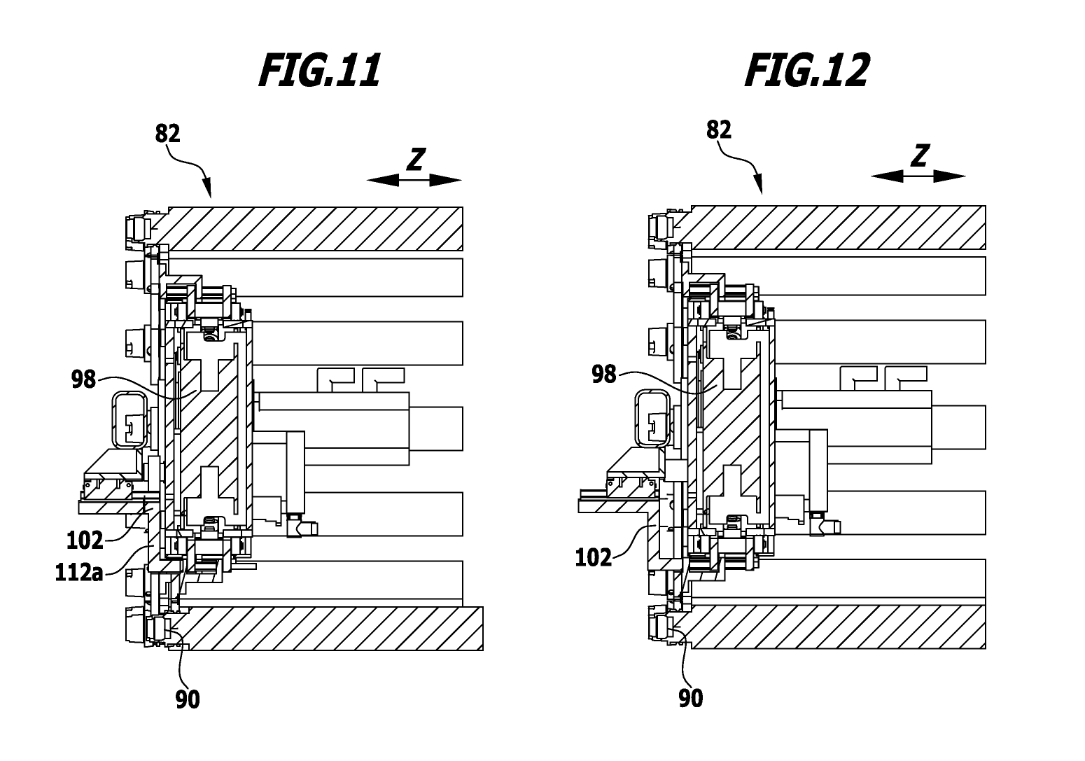

A further exemplary embodiment of a storage system as shown in FIGS. 6 to 11 and identified there as 80, comprises a storage device arranged on the machine frame 14 and corresponding to the storage device 34. Therefore, the same reference signs are used for identical elements. This storage device 34 itself constitutes a background magazine with a large number of storage spaces 56.

The storage system 80 has a chain-type storage device 82 as the second magazine. Said chain-type storage device 82 is arranged between the working space 38 and the first region 50 of the storage device 34. It is arranged, in particular, beneath the first region 50 and above the working space 38. The chain-type storage device 82 is arranged, in particular non-displaceably, on the machine frame 12. It comprises a circulating chain conveyor 84. Said circulating chain conveyor 84 has a chain 86 which is mounted, for example, on deflection rollers 88a, 88b. The chain 86 is configured endless and is closed. A circulating movement of the chain 86 on the deflection rollers 88a, 88b is driven by a drive 89. It is possible for a movement of the chain 86 to take place only in one direction or both forward and backward.

A plurality of storage spaces 90 is provided on the chain 86. For example, the storage spaces 90 each comprise a hollow taper shank (HSK) interface 91. Each storage space 90 is in a fixed relation to the chain 86 so that, when the chain 86 is transported, the storage spaces 90 are also transported.

The number of storage spaces 90 in the chain-type storage device 82 is smaller than the number of storage spaces 56 in the storage device 34. In one exemplary embodiment, the chain-type storage device 82 has thirty-four storage spaces 90.

One or more transfer stations 92 are associated with the chain-type storage device 82. A transfer station 92 has, in particular, one or more movable spaces corresponding to the spaces 76 so that a tool transfer from the storage device 34 to the chain-type storage device 82 can take place and vice versa. The chain-type storage device 82 communicates via the transfer station or transfer stations 92 with the first region 50 of the storage device 34.

The chain-type storage device 82 has a region 94 which faces toward the first region 50 of the storage device 34. It has an opposing region 96 which faces toward the machine bed 12. A transfer of tools between the tool spindles 18a, 18b and the chain-type storage device 82 can take place at the region 96. Via the region 96, the chain-type storage device 82 communicates with the tool spindles 18a, 18b.

The chain-type storage device 82 serves for changing tools both with the first tool spindle 18a and also with the second tool spindle 18b. For this purpose, the chain-type storage device 82 has a corresponding extent in the X-direction so that both the first tool spindle 18a and the second tool spindle 18b can be served by the chain-type storage device 82 and, in particular, by the region 96 thereof.

A lifting-out device 98 is arranged on the chain-type storage device 82. The lifting-out device 98 is associated with the tool spindles 18a, 18b. It is arranged at a lower region of the chain-type storage device facing toward the working space 38, said region comprising the region 96. Using the lifting-out device 98, a lifting-out movement can be performed at the chain-type storage device 82 in a direction parallel to a longitudinal extent of the tool spindle 18a, 18b, that is in the Z-direction. Said movement moves a storage space 90 with the corresponding interface 91. A typical lifting-out travel 100 (stroke) is in the order of 40 mm. With a lifting-out movement, a tool can be released from a tool spindle 18a, 18b or with a reverse lifting-out movement, a tool can be inserted into a tool spindle 18a, 18b and fixed.

It is possible, in principle, as described above, for the lifting-out device 98 to act upon a storage space in order to move the tool or to act directly upon a tool and to displace said tool directly.

In one exemplary embodiment, the lifting-out device 98 has a first lifting-out region 102 and a second lifting-out region 104. The first lifting-out region 102 is associated, in particular, with the first tool spindle 18a and the second lifting-out region 104 is associated with the second tool spindle 18b.

A lifting-out region 102 or 104 can act upon one or more storage spaces 90. In the case of the exemplary embodiment disclosed, each lifting-out region 102 or 104 acts upon three storage spaces.

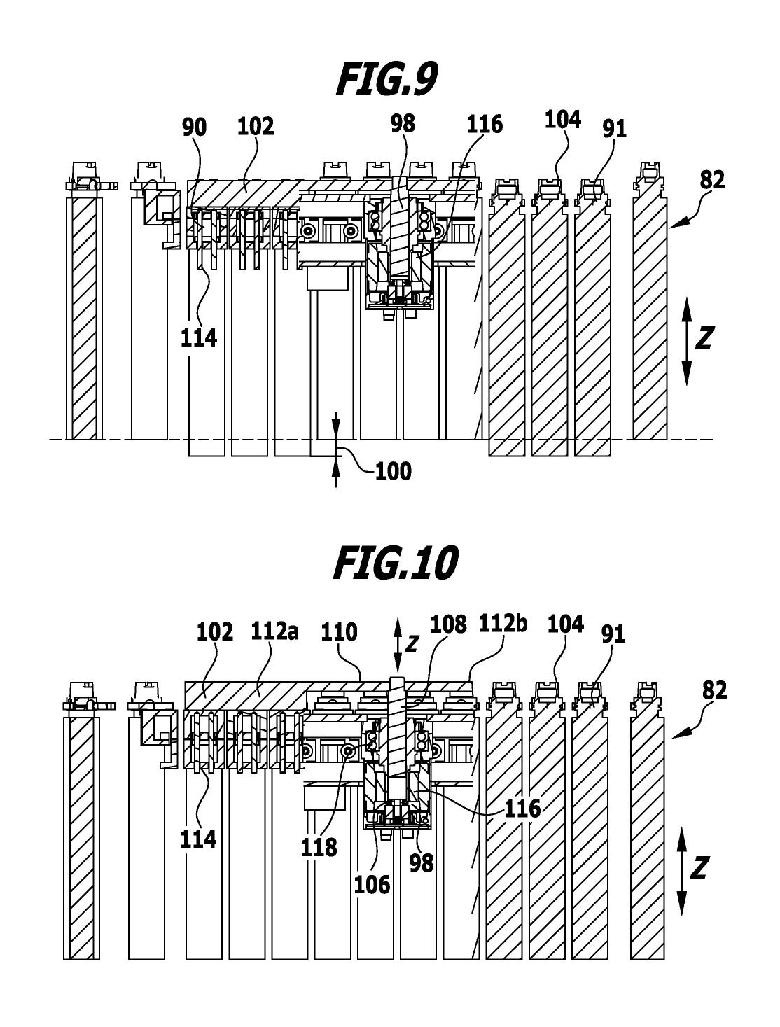

In one exemplary embodiment (see, in particular, FIGS. 9 and 10), the lifting-out device 98 comprises a central unit 106. Said device has a spindle 108 which is displaceable in the Z-direction. The first lifting-out region 102 and the second lifting-out region 104 are symmetrical to the spindle 108. For example, a bar 110, having a first region 112a and a second region 112b, is firmly connected to the spindle 108 and is therefore displaceable therewith. The first region 112a acts upon storage spaces 90 at one side of the spindle 108 (for example, to the left of the spindle 108) and the second region 112b acts upon storage spaces 90 at the other side of the spindle 108 (for example, to the right of the spindle 108).

For this purpose, the regions 112a, 112b are connected to pushing elements 114 of the respective storage spaces 90. By means of a Z-displacement of the spindle 108, via the bar 110, the pushing elements 114 are displaced and act on a corresponding tool held at the storage space 90 of said tool and displace the tool in the Z-direction, i.e. bring about the lifting-out travel 100.

A drive 116 is associated with the spindle 108 in order to cause the corresponding lifting movement. In principle, said drive 116 can be a motor drive or a fluid-powered drive. It is, for example, also possible for the drive 116 to consist of one or more elastic springs.

In one exemplary embodiment, the drive 116 is provided by means of an actuator which comprises a servomotor and a ball screw drive 118. The spindle 108 is part of the ball screw drive 118. The servomotor provides for the positioning and fixing of the spindle 108 in the +Z and -Z positions.

In an example shown in FIG. 10, the corresponding pushing elements 114 are not extended.

FIG. 9 shows the extended position. By means of the drive 116, the spindle 108 is driven in the Z-direction and thereby also moves the pushing elements 114.

In order to return the spindle, a return spring by means of which the non-extended position is reached can also be provided. It is also possible, in principle, for a spring to be provided in order to bring about the movement from the non-extended position into the extended position.

By means of the ball screw drive 118 with servomotor, the transition between the extended position and the non-extended position and conversely, between the non-extended position and the extended position can be brought about without any additional spring action and the corresponding positions shown can be fixed.

The storage system 80 according to the invention functions as follows.

The storage device 34 constitutes a background magazine with a larger number of storage spaces than the chain-type storage device 82. The chain-type storage device 82 constitutes a second tool magazine as a buffer store. The tool spindles 18a, 18b fetch tools directly from the chain-type storage device 82 or deliver tools thereto. The chain-type storage device 82 can accommodate a plurality of tools wherein the number of storage spaces 90 is smaller than the number of storage spaces 56 of the L-shaped storage device 36.

The chain-type storage device 82 has designated storage spaces, specifically those storage spaces on which the lifting-out device 98 acts. By means of the circulating chain conveyor 84, storage spaces 90 can be “converted” into such designated storage spaces, i.e. said storage spaces can be transported into the region of action of the lifting-out device 98.

The lifting-out device 98 is symmetrically constructed so that lifting-out from one or more storage spaces can be achieved with effect both for the first tool spindle 18a and also for the second tool spindle 18b.

The tool spindles 18a, 18b move toward storage spaces which are raised, i.e. pushed forward in the Z-direction, by means of a movement in the X-direction. In connection therewith, the tool spindles 18a, 18b have been brought with a prior movement in the Y-direction to the correct height position for a tool change.

The lifting-out device 98 brings about a lifting-out stroke of preferably at least two storage spaces 90. In this way, the respective tool spindle 18a or 18b can hand over a tool at the associated region of the chain-type storage device 82 at a storage space and, with a corresponding method, fetch a new tool at a further storage space. In the process, no further lifting-out movement need be performed therebetween for the respective tool spindle 18a, 18b. This saves time. Following the tool change and the movement away of the relevant tool spindle 18a or 18b, all the raised storage spaces can be reset through the return movement at the lifting-out device 98. This also saves time.

During the tool change with the lifting-out device 98, no circulation of the chain 86 takes place at the chain-type storage device 82.

Therefore, simultaneously with the tool change at the tool spindles 18a, 18b, a tool exchange can take place between the storage device 34 and the chain-type storage device 82. Therefore, the down time necessary for the exchange of tools at the tool spindles 18a, 18b can also be efficiently used for a tool change between the chain-type storage device 82 and the storage device 34.

Therefore, even in the case of complex workpiece machining operations for which a plurality of different tools must be provided, short chip-to-chip times can be achieved. A tool change can be carried out in a time-saving manner.

### REFERENCE SIGNS

10 Machining center
12 Machine bed
14 Machine frame
16 Tool carrier device
18a First tool spindle
18b Second tool spindle
20a Rotation axis
20b Rotation axis
22 Carriage
24 Carriage guideway
26 Drive device
28 Carriage
30 Carriage guideway
32 Workpiece holder
34 Storage device
36 Tool
38 Working space
40 Tool changing device
41 Control device
42 Switchgear cabinet
44 Front side
46 Rear side
48 Storage system
50 First region
52 Second region
54 Circulating conveyor
56 Storage location
58 Tool
60 Region
62 Bottom side
64 Floor
66 First disk-type storage unit
68 Second disk-type storage unit
70 Axis
72 Storage location
74 Transfer station
76 Space
78 Carriage
80 Storage system
82 Chain-type storage device
84 Circulating chain conveyor
96 Chain
88a,b Deflection roller
89 Drive
90 Storage location
91 Hollow taper shank interface
92 Transfer station
94 Region
96 Region
98 Lifting-out device
100 Lifting-out travel
102 First lifting-out region
104 Second lifting-out region
106 Central unit
108 Spindle
110 Bar
112a First region
112b Second region
114 Pushing element
116 Drive
118 Ball screw drive

1. A machine tool comprising:
a machine frame;
at least one tool spindle which is arranged on the machine frame and is displaceable relative thereto;
a workpiece holder; and
a storage device for tools which is arranged on the machine frame; wherein at least one rotatable disk-type storage unit for tools is arranged on the machine frame and communicates with the storage device and with the at least one tool spindle;
wherein a separate disk-type storage unit is associated with each tool spindle; and
wherein the storage device comprises a circulating conveyor.

2. The machine tool according to claim 1, said machine tool comprising at least one first tool spindle with which a first disk-type storage unit is associated and a second tool spindle with which a second disk-type storage unit is associated.

3. The machine tool according to claim 1, wherein the storage device for tools constitutes a first magazine for tools and the at least one disk-type storage unit constitutes a second magazine for tools.

4. The machine tool according to claim 3, wherein a storage capacity of the first magazine for tools is greater than the storage capacity of the at least one disk-type storage unit.

5. The machine tool according to claim 1, wherein the storage device has at least 30 storage spaces for tools.

6. The machine tool according to claim 1, wherein the at least one disk-type storage unit has between five and fifteen storage spaces for tools.

7. The machine tool according to claim 1, wherein the storage device has a region with storage spaces which lies above a working space and has a region which lies beside the working space.

8. The machine tool according to claim 7, wherein the region which lies beside the working space is at a spacing of not more than 1.5 m from a foundation on which a machine bed stands.

9. The machine tool according to claim 1, wherein the storage device has an L-shaped form in plan view.

10. The machine tool according to claim 1, wherein the circulating conveyor is configured as a chain conveyor.

11. The machine tool according to claim 1, said machine tool comprising at least one transfer station between the storage device and the at least one disk-type storage unit.

12. The machine tool according to claim 11, wherein the at least one transfer station is movable between the storage device and the at least one disk-type storage unit.

13. The machine tool according to claim 12, wherein the at least one transfer station has at least two receiving spaces.

14. The machine tool according to claim 11, wherein the at least one transfer station comprises a carriage which is displaceable on the machine frame on which the at least one disk-type storage unit is arranged.

15. The machine tool according to claim 1, wherein the at least one disk-type storage unit is arranged on a carriage which is displaceable on the machine frame.

16. The machine tool according to claim 15, wherein the carriage is displaceable at least in a first direction transversely to a first longitudinal direction of the at least one tool spindle.

17. The machine tool according to claim 1, said machine tool comprising an intermediate storage device for tools which communicates with the storage device and with the at least one tool spindle, wherein a lifting-out device is arranged on the intermediate storage device, by means of which lifting-out device a tool is displaceable in a direction parallel to a tool spindle longitudinal direction.

18. A method for changing tools on a machine tool wherein a first storage device and a second storage device are provided, wherein the second storage device communicates with the first storage device and with a tool spindle and a tool change at the tool spindle is carried out with the second storage device, wherein a separate second storage device is associated with each tool spindle and wherein the first storage device comprises a circulating conveyor by means of which storage spaces are transported in a closed circuit.
